(19) United States
(12) Patent Application Publication
(10) Pub. No.: US 2011/0189579 A1
(43) Pub. Date: Aug. 4, 2011

(54) ELECTROLYTE

(76) Inventors: Alexander Bismarck, Peterborough (GB); Natasha Shirshova, London (GB); Emile Smith Greenhalgh, London (GB); Joachim Steinke, London (GB); Milo Sebastian Peter Shaffer, London (GB)

(21) Appl. No.: 13/055,826

(22) PCT Filed: Jul. 24, 2009
(86) PCT No.: PCT/GB2009/001841

§ 371 Date: Apr. 12, 2011

(30) Foreign Application Priority Data
Jul. 25, 2008 (GB) 0813669.9

(51) Int. Cl. H01M 8/10; H01M 10/056; H01M 10/052; H01G 9/022

(52) U.S. Cl. 429/479; 429/188; 252/62.2

(57) ABSTRACT

An electrolyte includes a continuous meso- or nanoporous component and a polymer electrolyte phase having a conductive matrix or continuous conducting component. The continuous meso- or nanoporous component includes an interconnected porous structure and may, for example, be a monolith. When the porous component is contacted with the electrolyte phase, the porous component is filled with and integrated into the electrolyte phase.

The present invention relates to an electrolyte comprising a continuous meso- or nanoporous component and a polymer electrolyte phase, a process for the production of the polymer electrolyte and its use in electrochemical applications.

Gel polymer electrolytes have been used in power storage devices such as secondary lithium batteries and electrochemical supercapacitors. Compared with liquid electrolytes, solid state (gel) polymer electrolytes provide increased durability and reduced leakage; in addition, they are relatively cheap, easy to prepare, and have a wide voltage window. However, polymer electrolytes have a number of disadvantages, including their relatively low ionic conductivity.

Efforts to improve both the conductivity and mechanical properties of the electrolytes have included the addition of discrete nano-particles such as SiO₂, Al₂O₃, TiO₂ into the polymer electrolytes. The resulting ionic conductivity can be improved (up to 0.001 S/cm) but, despite improvements, the absolute mechanical properties are still quite poor (tensile strength typically only up to 2.5 MPa).

The addition of discrete nanoparticles (SiO₂, Al₂O₃, TiO₂) to the polymer electrolyte system does not yield an optimal geometry for simultaneously improving conductivity and mechanical performance of the electrolyte. It is understood in the art that only continuous reinforcement allows the mechanical performance of the filler phase to be fuller utilised. The use of particulates does not allow interfacial stresses to be sufficiently high to enable the reinforcing phase to impart its superior mechanical performance to the composite. Improvements in ionic conductivity are associated with the interphase between the electrolyte and the particles. In order to obtain efficient improvements in ionic conductivity, this interphase should span across the whole electrolyte material, forming a ‘percolated’ network. However, with the addition of discrete nanoparticles such as SiO₂, Al₂O₃ or TiO₂, this percolation occurs in a random, statistical fashion, leading to inefficient transport networks. The conduction paths are therefore convoluted and contain redundant loops, as well as trapped pockets of inactive electrolyte. In addition, the convex particles, occupy a large volume fraction compared to the surface area that they introduce. A further, practical concern for this type of system is low miscibility of the organic and inorganic phases due to their low compatibility. This low compatibility tends to lead to phase separation, which limits the loading fraction of particles that can be accommodated and introduces large agglomerates which can act as defects that contribute to mechanical failure. Poor distribution of the particles also leads to locally variable properties and can partly or entirely break the percolating network.

An alternative strategy relies not on hard particles but on interpenetrating polymer networks (IPNs). Here, two different polymer systems are polymerised in such a way that the two types of polymer chains interpenetrate. The goal is to manifest the mechanical or electrochemical advantages of the two systems, however, the outcome is typically an average performance manifesting the best properties of neither system.

The invention allows preparation of a new class of multifunctional electrolyte which combines high electrochemical and mechanical performance. The synthesis provides a means to create a uniform, highly ordered, bicontinuous (nano or meso) structure, with a high interfacial area. The present invention involves the addition of a continuous inorganic, for example ceramic, or stiff organic phase directly into an electrolyte system, preferably a polymer electrolyte system, resulting in improved conductivity and mechanical properties.

The first aspect of the invention therefore provides an electrolyte comprising a continuous meso- or nanoporous component and a continuous electrolyte phase, wherein the electrolyte phase comprises a conducting matrix such as an ionically-conducting but electrically insulating phase. Hence two continuous interpenetrated nano/mesostructed phases—one rigid, one electrolyte—is provided.

In an embodiment, the bicontinuous structure is a monolith and the respective phases—for example the rigid or structural continuous meso- or nanoporous component is a monolith or monolith component. For the purposes of this embodiment, the structural monolith is prepared from any readily templated material. The material preferably has a polar surface. In particular, the structural monolith is composed of a continuous inorganic material such as silica, titania, alumina and zinc oxide or a continuous stiff organic material such as a diglycidyl ether of bisphenol A (epoxy). The bicontinuous monolith may also be made with an inorganic phase plus an organic phase wherein the organic phase would be suitable for ion conduction. It will be appreciated that the electrolyte of the invention is provided for use in electrochemical applications such as fuel cells, batteries and electrochemical capacitors, etc.

The structural continuous meso- or nanoporous component of the first aspect is preferably composed of any readily templated material that is compatible with the other components of the electrochemical application and which is electrochemically stable under the operating conditions of the electrochemical application. It will be appreciated that the component comprises a continuous network of interconnected pores surrounded by a continuous, rigid structure. The component may therefore alternatively be any continuous meso- or nanoporous material.

The conducting matrix may comprise a salt. The electrolyte phase may therefore be provided as a liquid electrolyte phase comprising a salt solution or a molten salt. Examples of a salt suitable for use in the present invention include those currently used for battery, fuel cells and electrochemical capacitor or supercapacitor applications. For the purposes of this invention, the salts include lithium or ammonium salts, more particularly lithium or ammonium salts, such as perchlorate, hexafluoro phosphate, bis(oxalato)borate, trifluoromethane sulfonate or borofluoride.

In a preferred aspect of the invention, the conducting matrix additionally comprises a polymer. In a particularly preferred aspect of the invention, the conducting matrix comprises a salt and a polymer. For the purposes of this invention, the polymer is a polymer and/or an oligomer selected from poly(ethylene oxide), polyacrylonitrile, propylene carbonate, ethylene carbonate, gamma-butyl lactone or methylacetate. The salts of the present application are preferably dissolved into the polymer. If necessary, a plasticiser such as propylene carbonate, ethylene carbonate, succinic nitrile, butyroactone or even water, can be included to ensure dissolution of the salt into the polymer. The salt may be any appropriate electrolyte salt.

Where the electrolyte comprises a meso- or nanoporous monolith and an electrolyte phase comprising a conducting matrix, wherein said matrix comprises a polymer and a salt, the monolith, polymer and salt are preferably provided in a 1:1:1 weight ratio.

The production of an electrolyte comprising a continuous meso or nanoporous component and a continuous polymer electrolyte phase simultaneously provides a continuous phase for ionic conductivity and another continuous phase for mechanical robustness. In addition, the massively parallel, continuous interface area assists ionic conductivity by modifying the conformation of the electrolyte phase, without introducing the inefficiencies (e.g. redundant loops, dead spaces) of conventional particle-filled systems and assists in mechanical load transfer between the phases of the material. The ordered nature of the template used to produce the porous monolith allows the dimensions of the pores to be adjusted to optimise the thickness of the interphase with the electrolyte phase and the thickness of the inorganic phase to be adjusted to optimise mechanical performance of the electrolyte. The monolith of embodiments preferably provides a porous structure with pore sizes in the range of 1 to 1000 nm, preferably 1 to 100 nm, more preferably 2-10 nm, most preferably 3 to 5 nm. The negative surface curvature associated with bicontinuous phases ensures a very high surface area for the volume occupied by the solid material. In addition, the nanoscale dimensions of the structure are important. On the one hand, the intrinsic feature size is small enough not to weaken the structure excessively by acting as large defects (as agglomerates do in current technology). In particular, the length and thickness of the continuous structure improves both the compressive and shear properties of the electrolyte. On the other hand, the ‘struts’ of the mechanical phase are large enough to manifest their intrinsic mechanical rigidity, unlike interpenetrating polymer networks. Furthermore, the discontinuous microstructure will promote tortuous crack paths, crack direction and arrest, and thus inherent toughening mechanisms, which will enhance the durability of the resulting material. Lastly, this system intrinsically cannot exhibit large scale phase separation effects, thus device variability and failure associated with agglomeration or poor distribution of the silica are avoided.

The second aspect of the invention provides a process for the production of the electrolyte of the first aspect of the invention, said process comprising contacting a continuous meso- or nanoporous component with an electrolyte phase, wherein the electrolyte phase comprises a conducting matrix.

It will be appreciated that the continuous meso- or nanoporous component comprises an interconnected porous structure (e.g. a bicontinuous phase). When the porous component is contacted with the electrolyte phase, the porous component is filled with and integrated into the electrolyte phase.

Where the electrolyte phase comprises a polymer and a salt, the electrolyte phase can be produced by mixing the polymer with a salt using a homogenisation/shear dispersion technique. The electrolyte is usually prepared over a total period of 72 hours.

The inorganic or stiff organic porous component can be produced by a sol-gel process from an inorganic or stiff organic monolith precursor using a soft template. The soft template is preferably a triblock copolymer such as Pluronic, a copolymer consisting of the block EO and PO, a diblock co-polymer, or a non-ionic/cationic/anionic surfactant. The template is removed prior to the application of the electrolyte phase producing a monolith with an interconnected porous structure.

The porous component comprises a network of pores surrounded by a rigid structure. The scale and nature of the rigid structures and the pores can be adjusted independently by the use of different molecular and supramolecular templates (e.g. triblock copolymers with different molecular weights).

The templating method will therefore allow both the length and thickness of the monolith, the thickness of the pore walls and the pore size to be independently varied.

In an alternative feature, the electrolyte can be produced by forming a monolith precursor in the presence of an electrolyte phase as defined in the first aspect. For this process, the electrolyte phase can be passive in the course of the monolith formation or can act as the template for the monolith formation or can react simultaneously to form the appropriate electrolyte.

Preferred monolith precursors for use in a sol-gel process include alkoxides, acetates, oxides, silicates, aluminates, halide, or esters of aluminium, cerium, chromium, iron, lithium, magnesium, silicon, tin, titanium, yttrium and/or zinc. Alternatively, the precursor can be an alkyl metal species, such as a silane, an alkyl zinc or an alkyl aluminium, etc. In a preferred feature, the precursor is an alkoxide or halide of silicon, titanium, zinc or aluminium. The alkoxide is preferably methoxide, ethoxide, propoxide, isopropoxide, butoxide or phenoxide. The ester is preferably ethyl hexanoate. Other materials which can be used in a sol-gel material synthesis are also suitable for use as an inorganic monolith precursor. A particular example of a monolith precursor is tetraethyl orthosilicate.

The third aspect of the invention provides the electrolyte of the invention for use in a number of conventional electrochemical applications, particularly for use in a polymer electrolyte fuel cell, a polymer (lithium) battery and a supercapacitor. All of these applications benefit from electrolytes with high ionic conductivity combined with low volatility and high mechanical robustness. It will be appreciated that the electrolyte of the present application can be used to replace conventional electrolytes in such electrochemical applications. In a particular feature of the third aspect of the invention, the electrolyte is provided for use in a multifunctional structural energy storage device, where electrolytes with particularly high mechanical properties are desired.

The third aspect of the invention therefore provides an energy storage device having a first and a second electrode separated by a polymer electrolyte, wherein said polymer electrolyte comprises a continuous meso- or nanoporous component and a continuous electrolyte phase or monolith component. Preferably, there is provided an energy storage device comprising a super capacitor having a first and a second electrode separated by a polymer electrolyte, wherein said polymer electrolyte comprises a continuous meso- or nanoporous continuous component and an electrolyte phase, wherein said electrolyte phase comprises a continuous conducting matrix.

The supercapacitor of the third aspect preferably comprises a capacitor based on double-layer effects or pseudocapacitance.

The electrodes are preferably spaced by an insulating spacer, wherein the insulating spacer is preferably a glass fibre mat.

In particular, the energy storage device comprises a plurality of electrode pairs. Furthermore, the first electrode and/or the second electrodes can be pseudo capacitive electrodes.

The mechanical strength of the device of the third aspect of the invention is provided by using a composite of woven or braided carbon fibre electrodes and the polymer electrolyte of the first aspect of the invention. Unlike, for example, fuel cell solutions, structural components directly provide the energy storage, rather than simply being a small component of an energy system which is mostly liquid fuel. Double-layer supercapacitors also avoid the volume changes and electrode consumption associated with batteries, and, unlike Li-ion systems in particular, have only modest packaging requirements, making them much more adaptable to a range of structural roles.

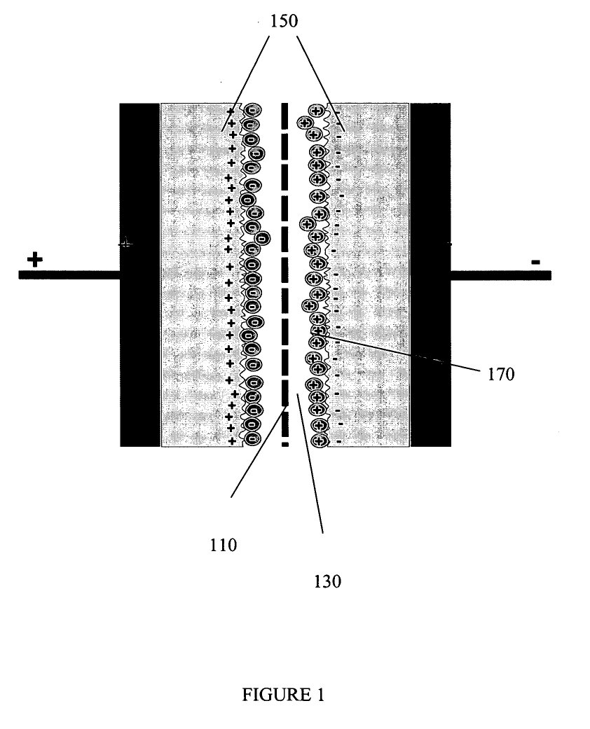

The most common known form of supercapacitor is based on the electrochemical double layer. FIG. 1. shows a schematic diagram of a generic supercapacitor based on the use of the electrochemical double layer. In double-layer capacitors, the energy is stored by the accumulation of charge 170 at the boundary between electrode 150 and electrolyte 130. The amount of stored energy is a function of the accessible electrode surface area (which is much greater than the simple geometric area), the size and concentration of the ions dissolved in the polymer electrolyte, and the level of the electrolyte decomposition voltage. Supercapacitors consist of two electrodes 150, a separator 110, and an electrolyte 130. The two electrodes 150 may be made of activated carbon, a weak granulated material, providing a high surface area. The electrodes 150 are physically separated by the electrolyte 130, often with an additional separator membrane 110; the electrolyte region 130/110 must be ionically-conducting but electrically insulating. As the dissociation voltage of the organic electrolytes is generally less than 3V, the maximum voltage for a supercapacitor is lower than conventional dielectric capacitors; however, the overall energy and power density is usually higher. Stacks of supercapacitors can be connected in series or parallel. Usually, the electrodes and electrolytes in these systems have no structural performance other than to aid fabrication and provide internal integrity.

According to the third aspect of the present invention, carbon fibres are activated in any appropriate manner, as will be well known to the skilled reader, to provide electrodes 150 with the dual functionality of energy storage and mechanical properties. Referring to the general geometry of FIG. 1, conventional electrodes are replaced by layers of specially activated but structural carbon fibre electrodes 150 and the surface is activated to increase the surface area, whilst not damaging the load-bearing core. The electrodes 150 are separated by an insulating space layer (110), preferably a glass/polymer fibre layer or a porous insulating film. The mesoporosity of the electrodes gives rise to a high contact area between electrolyte and electrode and, thus, the potential for high energy storage.

The electrodes are bonded together by the polymer electrolyte of the first aspect of the invention which provides simultaneously high ionic conductivity/mobility and good mechanical performance (particularly compressive strength). In an embodiment, the electrolyte resin has significant structural capability so as to resist buckling of the fibres in the electrode and provide significant stress transfer.

The electrodes 210 can be formed of unidirectional, woven NCF or 3D braided continuous fibres, and can be fabricated using standard composite laminate technology known to the skilled reader; for example, liquid resin (such as Vacuum Assisted Resin Transfer Molding, Resin Film Infusion, Rein Transfer Moulding and Resin Infusion Under Flexible Tooling) or pre-preg technologies, as will be familiar to the skilled reader.

To fabricate the supercapacitor two layers of woven carbon fibre mats (200 g/m²) are separated by a woven glass fibre mat, in particular samples of carbon fibre mat 10×10 cm are cut sandwiching the glass fibre mat which is cut slightly larger. Prior to impregnation, the mats are activated using KOH as an activation agent. KOH was mixed with water to form thick slurry. The carbon fibre was impregnated with the slurry (ratio of KOH was 1:1 (w/w)) and left for 2 h at room temperature. The impregnated fibre was transferred to a horizontal tube furnace and heated to 800° C. (heating rate 5° C./min) for 1 h in a flow of N₂ (0.5 l/min). The samples were cooled to room temperature in a nitrogen atmosphere. Activated carbon fibre (Acf) was washed with distilled water to eliminate excess KOH until the washes reached pH7 and dried.

Two piles of the carbon fibres with glass fibre in between were placed into a mould and the reaction mixture to prepare the inorganic monolith was poured in (the ratio was 1:1 w/w). The system was then held for 36 h at 14° C. for aging and then overnight at 60° C. After synthesis, the template was removed and formed the mesoporous silica composite and was filled with polymer electrolyte (1:1 wt % mesoporous silica composite to polymer-electrolyte) using soaking method followed by removing extra electrolyte using filter paper.

The fourth aspect of the invention provides an electrical device comprising an energy storage device of the third aspect of the invention. For the purposes of this invention, the electrical device can be a laptop computer, a mobile phone, a hybrid electrical vehicle battery, an emergency equipment device, a propulsion system device or a downhole energy supply.

All preferred features of each of the aspects of the invention apply to all other aspects mutatis mutandis.

The invention will now be illustrated with reference to the following non-limiting examples.

### EXAMPLE 1

The synthesis of the multifunctional electrolyte is carried out as described below. Pluronic (P123) was dissolved in a mixture of ethanol (5 g) and aqueous HCl (1 mol/L) (0.2 g) and stirred until a homogenous solution formed. While still stirring, tetraethyl orthosilicate (TEOS) (2.08 g, 2.23 ml) was added to the solution and the mixture was further stirred for 10 min. The solution described above was then transferred into a dish and aged at 14° C. for 36 h in air. The silica gel was covered with a layer of liquid paraffin (2 to 3 mm), heated to 90° C. and held at this temperature for 12 h to completely remove all the ethanol. The residue liquid paraffin on the surface of the products was removed by using filter paper. After this the surfactant was washed from the silica structure and the nanopores back-filled with polyacrylonitrile (PAN) electrolyte gel. PAN gel was synthesised using ethylene carbonate (EC) as a plasticiser, propylene carbonate (PC) as a solvent, PAN and tetrabutyl ammonium hexafluorophosphate (TBAPF₆) as a conducting electrolyte. PAN was dried under vacuum at 75° C. for 24 h. For the BET analysis the silica monolith was washed with EtOH for 24 h to remove the templating surfactant (Pluronic) and then dried in a vacuum oven at 70° C. to a constant weight. For the electrochemical analysis after synthesis the mesoporous silica monolith was filled with polymer electrolyte using a soaking method followed by the removing extra electrolyte with filter paper. For the formation of the polymer gel, TBAPF₆ (3.5 wt. %) was dissolved in EC (57.3 wt. %) and PC (31.5 wt. %) at room temperature. After complete dissolution PAN (7.7 wt %), was mixed into this solution and placed on a preheated hot plate at 110° C. with stirring, until a transparent, very viscous solution formed (after about 2-3 min).

The properties of the formed silica monoliths depend on the ratio between TEOS and Pluronic as well as thickness of the reaction layer. The monoliths with surface area from 1 to 276 m²/g and average pore diameter from 4.4 to 5.4 nm were obtained. The electrical conductivity of the silica monolith filled with PAN gel electrolyte was in a range 0.01-21.8 mS/cm.

### EXAMPLE 2

In a second example, a MPS based composite is filled with PAN electrolytes.

Two carbon fibre mats, with a glass fibre mat in between, were placed into a mould and MPS reaction mixture was poured in (the ratio was 1/1 w/w). The MPS reaction mixture was prepared according to the following procedure. Pluronic (1 g) was dissolved in a mixture of 5 g of ethanol and 0.2 g of aqueous HCl (1 mol/L) and stirred until a homogenous solution formed. Whilst still stirring, 2.08 g (2.23 ml) TEOS was added to the solution and the mixture was stirred for a further 10 min. This solution was then transferred into a dish and aged at 14° C. for 36 h in air. Silica gel was covered with a layer of liquid paraffin (2 to 3 mm), heated to 90° C. and held at this temperature for 12 hours to completely remove all of the ethanol. The residue liquid parafin on the surface of the products was removed using filter paper.

The mould containing the fibres and reaction mixture was then held at 14° C. for 36 hours, and then placed into an oven at 60° C. for 12 hours to remove the residual EtOH. The surfactant was removed by multiple washing of the composite in EtOH. The composite was then dried in the vacuum oven overnight at 70° C. The mesoporous silica composite was then filled with PAN gel electrolyte (1:1 wt.-% mesoporous silica composite to polymer electrolyte) using a soaking method followed by the removal of the excess electrolyte by filtration. PAN gel electrolyte was prepared as described above (example 1).

The specific capacitance of the produced composite was determined by impedance spectroscopy and was in the range 2.16-10.6 mF/g depending on the type of the used carbon fibres.

### Carbon Fibre Details

PAN-based woven (five harness satin weave) HTA carbon fibre cloths (862.0200.01) supplied by Tissa Glasweberei AG (Oberkulm, Switzerland), with an areal density 200 μm⁻² and thickness of the woven mat of 0.27 mm were used as precursor fibres to produce activated carbon fibre composites in this work. Industrially activated carbon fibres (AW 1114, provided by Taiwan Carbon Technology Co, Ltd. Taichung, Taiwan) with a specific surface area of 1100 m²/g also were used for comparison. The glass fibre (GF) woven 6K (twill weave) cloth with areal density 250 μm⁻² and thickness of the woven mat of 0.24 mm was also provided by Tissa Glasweberei AG (Oberkulm, Switzerland).

1. An electrolyte comprising a continuous meso- or nanoporous component and an electrolyte phase, wherein the electrolyte phase comprises a continuous conducting component.

2. The electrolyte as claimed in claim 1 wherein the continuous meso- or nanoporous component is a monolith.

3. The electrolyte as claimed in claim 2 wherein the monolith is one selected from the group including silica, titania, alumina and zinc oxide.

4. The electrolyte of claim 1 wherein the continuous meso- or nanoporous component is rigid.

5. The electrolyte as claimed in claim 1 wherein the conducting component includes a matrix which comprises a salt and a polymer and/or solvent.

6. The electrolyte as claimed in claim 5 wherein the polymer is selected from poly(ethylene oxide, polyacrylonitrile, propylene carbonate, ethylene carbonate, gamma-butyl lactone or methylacetate.

7. The electrolyte as claimed in claim 5 wherein the salt is a lithium or ammonium salt.

8. A process for the production of an electrolyte as claimed in claim 1 comprising contacting a continuous meso- or nanoporous component with an electrolyte phase, wherein the electrolyte phase comprises a continuous conducting component.

9. A process for the production of an electrolyte as claimed in claim 7 comprising forming a continuous meso- or nanoporous component in the presence of an electrolyte phase as claimed in claim 1.

10. The use of an electrolyte as claimed in claim 1 in an energy storage device comprising a super capacitor having a first and a second electrode separated by a polymer electrolyte, wherein said electrolyte comprises a continuous meso- or nanoporous component and an electrolyte phase, wherein said electrolyte phase comprises a continuous conducting component.

11. An energy storage device comprising a super capacitor having a first and a second electrode separated by an electrolyte, wherein said electrolyte comprises a continuous meso- or nanoporous component and an electrolyte phase, wherein said electrolyte phase comprises a conducting matrix.

12. A laptop computer, a mobile phone, a hybrid electrical vehicle battery, an emergency equipment device, a propulsion system device or a downhole energy supply comprising an energy storage device as claimed in claim 11.

13. An energy storage device, cell, battery, fuel cell or lithium-ion battery comprising an electrolyte as claimed claim 1.

14. A bicontinuous electrolyte comprising an interspersion of a meso- or nanoporous component and an ion conductor.
